(19) United States
(12) Patent Application Publication
(10) Pub. No.: US 2026/0113395 A1
(43) Pub. Date: Apr. 23, 2026

(54) Interactive Phone Holder and Intelligent Interactive Method

(71) Applicant: TANGIBLEFUTURE (DONGGUAN) INTELLIGENT HARDWARE CO., LTD., Dongguan , Guangdong (CN)

(72) Inventors: Xiaohui Zhang, Dongguan City, Guangdong Province (CN); Wei YOU, Dongguan City, Guangdong Province (CN); Qiang WANG, Dongguan City, Guangdong Province (CN)

(21) Appl. No.: 18/681,066

(22) PCT Filed: Sep. 8, 2023
(86) PCT No.: PCT/CN2023/117609

§ 371 Date: Feb. 4, 2024

(30) Foreign Application Priority Data
Sep. 8, 2023 (WO) PCT/CN2023/117609

(51) Int. Cl. H04M 1/04; G06V 40/16; H04M 1/72409; H04M 1/72412; H04M 1/72427; H04M 1/72454; H04M 1/72466

(52) U.S. Cl. CPC H04M 1/04; H04M 1/724098; H04M 1/72412; H04M 1/72427; H04M 1/72454; G06V 40/166; H04M 1/72466; H04M 2250/52

(57) ABSTRACT

An interactive phone holder and intelligent interaction method, the method includes the steps of generating a control signal by a phone and performing a corresponding emotional expression group by the phone and the phone holder which cooperate with each other, wherein the emotional expression group includes: displaying at least one of expression pattern and expression animation by the phone, performing at least one basic action by the phone holder, and adjusting a status of an information indicator light on said phone holder in one or more ways.

### FIELD OF INVENTION

The present invention relates to smart interactive technology, and more particularly to an interactive phone holder and intelligent interactive method.

### DESCRIPTION OF RELATED ARTS

In the current trend of the great development of informationization in society, people's communication with virtual information and the non-material world is becoming increasingly close and frequent. This trend has led to a narrowing of the interaction interface between people and the external world, and the screen has become the most important carrier of human-computer interaction.

In this case, the deformable interface has become a new method of interacting with computers, which uses the dynamic changes in the physical shape of the device for input and output. In the past twenty years, this interactive interface has had different names: “graspable user interface”, “tangible user interface”, “tangible interaction”, “physical-digital interaction and digitally enhanced physical space”. In the development of human-computer interaction, tangible interaction theory has become a very worthy direction of attention and research. At the same time, in the field of mobile devices, deformable interaction mechanisms have been proven to be particularly suitable for mobile devices. For example, they can be used to improve usability and enhance interpersonal communication.

Therefore, applying the concept of tangible interaction to the field of smartphones is highly valuable as it provides other movable interactive ports besides the screen.

### SUMMARY OF THE PRESENT INVENTION

The invention is advantageous in that it provides an intelligent interactive system and method for an interactive phone holder, wherein the intelligent interactive system for the interactive phone holder provides a new interaction solution between the phone and the phone peripheral device.

Another advantage of the present invention is to provide an intelligent interactive system and method for an interactive phone holder, wherein the intelligent interactive system for the interactive phone holder provided by the present invention enables multi-dimensional interaction between the user and the phone holder used as a phone peripheral device, so as to improve the interactivity between the intelligent interactive system for the interactive phone holder and the user.

Another advantage of the present invention is to provide an intelligent interactive system and method for an interactive phone holder, wherein the intelligent interactive system for the interactive phone holder provides a new recognition and connection solution between the phone and the peripheral device.

Another advantage of the present invention is to provide an intelligent interactive system and method for an interactive phone holder, wherein the intelligent interactive system for the interactive phone holder can achieve interaction between the user and the phone holder through the control of the phone holder by the phone, and the controller of the phone has a higher computing power, so as to reduce the computing power burden of the controller of the phone holder.

Another advantage of the present invention is to provide an intelligent interactive system and method for an interactive phone holder, wherein the intelligent interactive system for the interactive phone holder can achieve information and emotional interaction between the phone holder and the user by displaying different interfaces and interactive expressions on the phone.

Another advantage of the present invention is to provide an intelligent interactive system and method for an interactive phone holder, wherein the intelligent interactive system for the interactive phone holder can achieve physical video chat interaction through remote control.

Another advantage of the present invention is to provide an intelligent interactive system and method for an interactive phone holder, wherein the intelligent interactive system for the interactive phone holder can map the surrounding environment through the phone as the basis for path planning of the phone holder.

Another advantage of the present invention is to provide an intelligent interactive system and method for an interactive phone holder, wherein the intelligent interactive system for the interactive phone holder can control a lighting device on the phone holder through the phone to achieve lighting and interaction functions.

In order to achieve at least one of the above advantages or other advantages and objectives, according to one aspect of the present invention, the present invention provides an intelligent interaction method comprising the following steps.
(a)Generate a control signal by a phone which is communicatively connected to a phone holder; and
(b)Based on the control signal, perform a corresponding emotional expression group by the phone and the phone holder which cooperate with each other, wherein the emotional expression group comprises: displaying at least one of expression pattern and expression animation by the phone, and performing at least one basic action by the phone holder.

In some embodiments, the expression pattern comprises one of happy pattern, sad pattern, angry pattern, and contempt pattern, wherein the expression animation comprises one of taking pictures animation, listening animation, looking right animation, angry animation, surprised animation, and contempt animation, wherein the basic action comprises one of forward movement, backward movement, left turn, right turn, forward tilt, and backward tilt.

In some embodiments, when the phone holder performs the basic action of forward movement, the phone holder moves forward as a whole; when the phone holder performs the basic action of backward movement, the phone holder moves backward as a whole; when the phone holder performs the basic action of left turn, the phone holder turns left as a whole; when the phone holder performs the basic action of right turn, the phone holder turns right as a whole; when the phone holder performs the base action of forward tilt, a holding element of the phone holder rotates forward; when the phone holder performs the basic action of backward tilt, the holding element of the phone holder rotates backward.

In some embodiments, the emotional expression group further comprises a step of adjusting a status of an information indicator light on the phone holder in one or more ways, wherein the status of the information indicator light comprises one of continuous lighting, blinking, gradient, left sweep, right sweep, and center diffusion, wherein when the information indicator light is in a continuous state, within a first preset time, the information indicator light maintains the same light color and remains in a lit state; when the information indicator light is in a flashing state, within a second preset time, the information indicator light switches between two light colors or switches between an on state and an off state; when the information indicator light is in a gradient state, within a third preset time, the information indicator light gradually switches from one light color to another light color in a time difference manner; when in a left sweep state, a plurality of the information indicator lights transition from one light color to another light color from left to right; when in a right sweep state, said plurality of information indicator lights transition from one light color to another light color from right to left; when in a center diffusion state, the plurality of information indicator lights transition from one light color to another light color from a centrally located information indicator light to a peripherally located information indicator light.

In some embodiments, a control command of the phone holder is triggered by sensing data of sensors of the phone holder, wherein a step of sending a control signal from the phone comprising the steps of generating sensing data by at least one the sensor of the phone holder, sending a signal to the phone based on the sensing data by a holder controller of the phone holder, and generating the control signal by the phone based on the signal sent by the phone holder.

In some embodiments, the sensors of the phone holder comprises one of cliff sensor, obstacle avoidance sensor, TOF distance sensor, and touch sensor.

In some embodiments, the step of generating the control signal by the phone comprises the steps of:
generating cliff distance sensing data by the cliff sensor of the phone holder located at a front of the phone holder, wherein the cliff distance sensing data is within a preset cliff sensing distance range;
sending a signal to the phone based on the cliff distance sensing data by the holder controller of the phone holder; and
generating the control signal by the phone based on the signal sent by the phone holder, wherein based on the control signal, the phone and the phone holder cooperate with each other to perform the corresponding emotional expression group comprising: displaying a surprised animation by the phone, retreating the phone holder, and then turning the hone holder left at a preset angle.

In some embodiments, the phone triggers control instructions to the phone holder based on sensing data of the phone, wherein the step of generating at least one control signal for the phone comprises the steps of generating sensing data by at least one sensor of the phone, and generating the control instructions by the phone based on the sensing data of the phone.

In some embodiments, the at least one sensor of the phone comprises one of phone acceleration sensor, phone gyroscope, phone gyroscope, and camera.

In some embodiments, the acceleration sensor of the phone generates acceleration data, in response to the acceleration data exceeding a preset acceleration threshold, and the phone not executing an impact detection program, the phone generates the control instructions; based on the control signal, the phone and the phone holder cooperate with each other to perform the corresponding emotional expression groups comprising: the phone first displays a surprised animation, then displays a disdain animation, the phone holder performs a preset first distance retreat, then tilts back at a preset first angle, then moves forward at a preset second distance, and then tilts forward at a preset second angle.

In some embodiments, the phone triggers a control command of the phone holder through sensing data of the phone, wherein the step of generating at least one control signal by the phone comprises the steps of:
generating sensing data by at least one sensor of the phone;
generating sensing data by at least one sensor of the phone holder;
sending a signal to the phone from the phone holder based on the sensing data generated by the at least one sensor of the phone holder; and
generating the control signal based on the sensing data generated by the at least one sensor of the phone and the signal sent by the phone holder.

In some embodiments, the intelligent interaction method further comprises the following steps:
keeping the phone on the phone holder;
performing face recognition through the phone;
in response to the phone identifying the target face, obtaining the position relationship between the target face and the phone;
sending a control signal to the phone holder based on the position relationship between the target face and the phone; and
moving the phone holder based on the control signal.

In some embodiments, the intelligent interaction method further comprises the following steps:
keeping the phone of an owner on the phone holder;
controlling the phone of the owner and a phone of a remote video chat object to enter a remote video chat mode;
sending a remote control signal to the phone of the owner from the phone of the remote video chat object;
receiving the remote control signal by the phone of the owner and sending a remote recognition control signal to the phone holder holding the phone of the owner;
moving the phone holder based on the remote recognition control signal.

In some embodiments, the intelligent interaction method further comprises the following steps:
holding the phone in the phone holder;
transmitting sensing data of a cliff sensor on the phone holder to the phone; and
based on image data from a camera, sensing data from an accelerometer of the phone, and sensing data from an electronic compass of the phone.

According to another aspect of the present invention, the present invention provides an interactive phone holder comprising an installation base and a magnetic holding element provided on the installation base, wherein the magnetic holding element comprises a holding shell, a magnetic attracting member proved on the holding shell; and a hall sensor installed on the holding shell.

According to some embodiments, the magnetic holding element is movable mounted to the installation base in a manner that the magnetic holding element is allowed to be switched between a forward tilt state and a backward tilt state.

According to some embodiments, the interactive phone holder further comprises a driving motor and a moving element which is driven by the driving motor to shift between forward movement, backward movement, left turn and right turn.

According to some embodiments, the interactive phone holder further comprises one of a cliff sensor, an obstacle avoidance sensor, and a TOF distance sensor which is mounted on the installation base.

According to some embodiments, the interactive phone holder further comprises one or more information indicator lights mounted on the installation base.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a schematic diagram illustrating the interactive relationship between a interactive phone holder and a phone according to a preferred embodiment of the present invention.

FIG. 2 is a perspective view of the interactive phone holder according to the above preferred embodiment of the present invention.

FIG. 3 is perspective view illustrating the connection between the interactive phone holder and the phone according to the above preferred embodiment of the present invention.

FIG. 4 is a perspective view illustrating an internal structure of the interactive phone holder according to the above preferred embodiment of the present invention.

FIG. 5 is a perspective view of an interactive phone holder according to an alternative mode of the above preferred embodiment of the present invention.

FIG. 6 is a schematic diagram illustrating expression patterns of the interactive phone holder according to the above preferred embodiment of the present invention.

FIGS. 7 to 12 are respectively schematic diagrams illustrating expression animations of the interactive phone holder according to the above preferred embodiment of the present invention.

FIG. 13 is a schematic diagram illustrating the face tracking process in the smart interaction method of the interactive phone holder according to the above preferred embodiment of the present invention.

FIG. 14 is a schematic diagram illustrating the process of remote interaction between the phone and the peripheral device in the intelligent interaction method according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

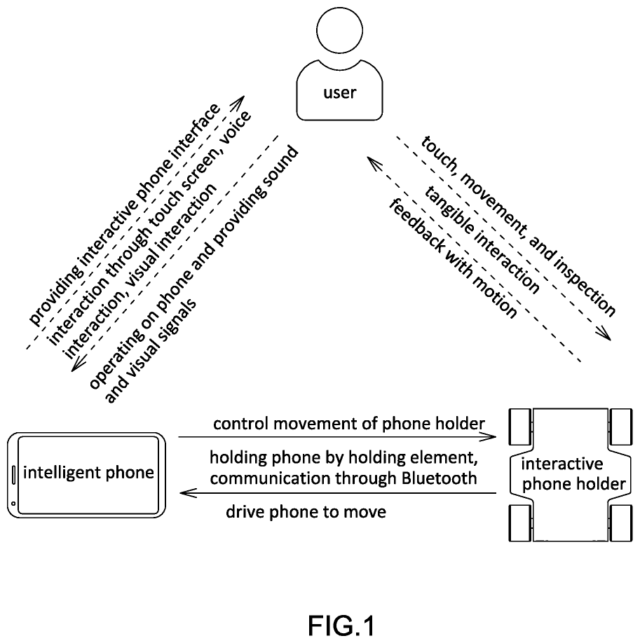

As shown in FIGS. 1 to 14, an intelligent interactive system for an interactive phone holder is disclosed according to a preferred embodiment of the present invention. As shown in FIG. 1, the intelligent interactive system comprises a phone 200 and a phone holder 100, wherein the phone holder 100 is communicatively connected to the phone 200, for example, the phone holder 100 can be connected to the phone 200 via Bluetooth. Specifically, the phone 200 comprises a phone body and a phone controller installed on the phone body, and the phone holder 100 comprises an installation base 10 and a holder controller 20 installed on the installation base 10. The phone controller and the holder controller 20 are communicatively connected, so that the phone holder 100 can receive instructions sent from the phone 200 and can also send corresponding feedback signals to the phone 200. The holder controller 20 can be implemented as an embedded microcontroller unit (MCU).

In this embodiment of the present invention, the shape of the installation base 10 of the phone holder 100 is not limited and can be designed according to requirements, such as car shape, tank shape, cartoon character shape, etc. In a specific example of the present invention, the shape of the phone holder 100 is implemented as a tank shape, and the installation base 10 comprises a base portion 11 and an upper mounting portion 12 mounted on the base portion 11.

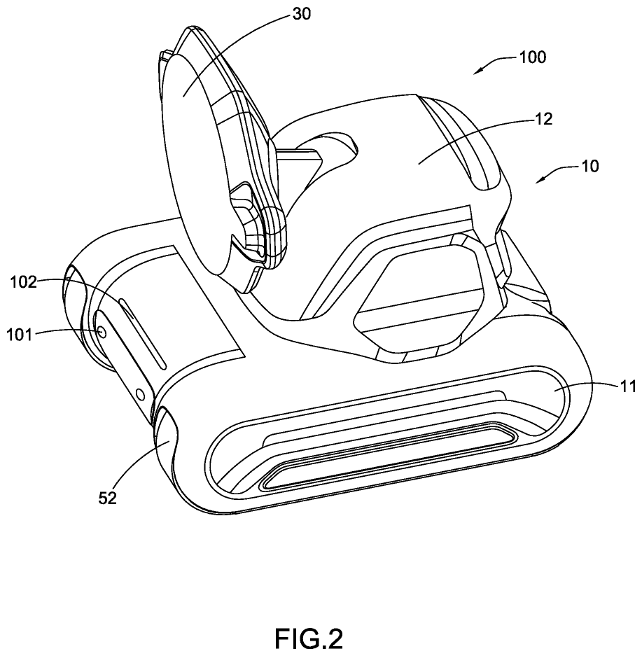

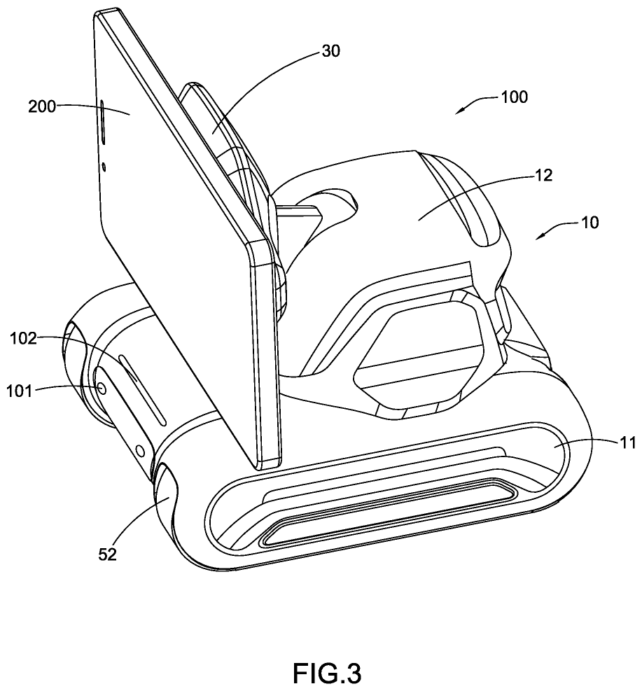

In this embodiment of the present invention, the phone holder 100 further comprises a holding element 30 arranged on the installation base 10, and the holding element 30 is used to place the phone 200 and keep the phone 200 in a specific position, as shown in FIGS. 2 and 3. The manner in which the holding element 30 keeps the phone 200 in a predetermined position is not limited to the present invention.

In some embodiments of the present invention, the holding element 30 holds the phone 200 in a predetermined position by magnetic attraction, and the holding element 30 is implemented as a magnetic holding element 31. Specifically, the holding element 30 comprises a holding shell 311 and at least one magnetic attracting member 312 installed on the holding shell 311, so that when the phone 200 with a corresponding magnetic structure (such as a magnetic ring) approaches the phone holder 100, the phone 200 is magnetically attracted to the phone holder 100 by the magnetic holding element 31. In some embodiments, the magnetic attracting member 312 of the magnetic holding element 31 can also cooperate with the magnetic structure installed on the phone 200 to achieve charging of the phone 200 by the phone holder 100.

More specifically, the magnetic holding element 31 has a holding surface 3111 and an opposite surface 3112 which is opposite to the holding surface 3111. When the phone 200 is held by the magnetic holding element 31 through magnetic attraction, a back of the phone 200 faces the holding surface 3111 of the magnetic holding element 31 and is at least partially attached to the holding surface 3111 of the magnetic holding element 31.

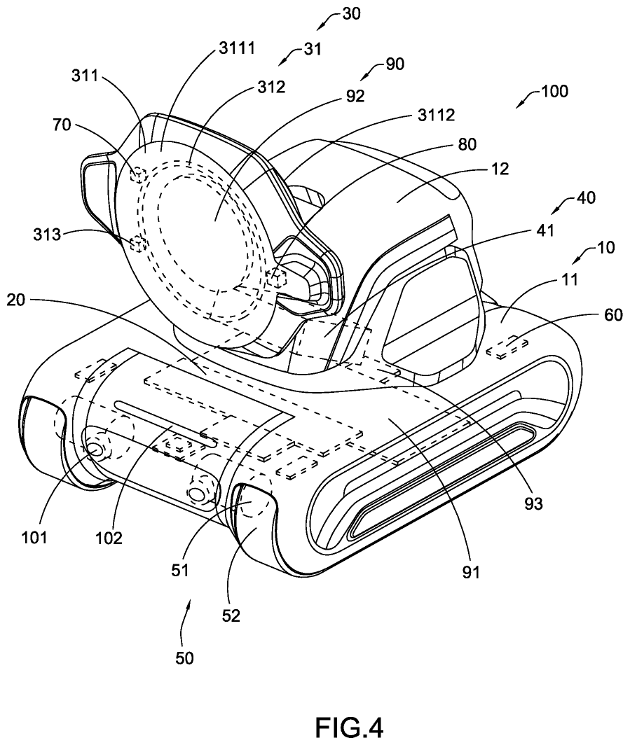

In some embodiments of the present invention, as shown in FIG. 4, the magnetic holding element 31 also comprises a hall sensor 313 installed on the holding shell 311. The hall sensor 313 is adjacent to the magnetic attracting member 312 and is used to detect whether the phone 200 is successfully connected to the magnetic attracting member 312 through magnetic attraction. Specifically, when the phone 200 is not magnetically connected to the magnetic holding element 31, the magnetic field generated by the magnetic attracting member 312 of the magnetic holding element 31 is in a stable state, correspondingly, the magnetic field around the hall sensor 313 adjacent to the magnetic attracting member 312 is also in a stable state. When the phone 200 is magnetically connected to the magnetic holding element 31, the magnetic field around the magnetic attracting member 312 changes, and the magnetic structure of the phone 200 interacts with the magnetic attracting member 312 of the magnetic holding element 31, generating a new magnetic field and gradually entering a stable state, correspondingly, the magnetic field around the hall sensor 313 adjacent to the magnetic attracting member 312 is in another stable state. The hall sensor 313 is capable of sensing changes in the magnetic field around it. When the hall sensor 313 senses a change in the magnetic field around it, it is determined that the phone 200 is attracted to the phone holder 100.

In this embodiment of the present invention, the hall sensor 313 of the magnetic holding element 31 is communicatively connected to the holder controller 20, so that the holder controller 20 can receive a signal from the hall sensor 313 of the magnetic holding element 31 and transmit the corresponding signal to the phone 200. The phone 200 determines whether it is magnetically connected to the phone holder 100 based on this signal.

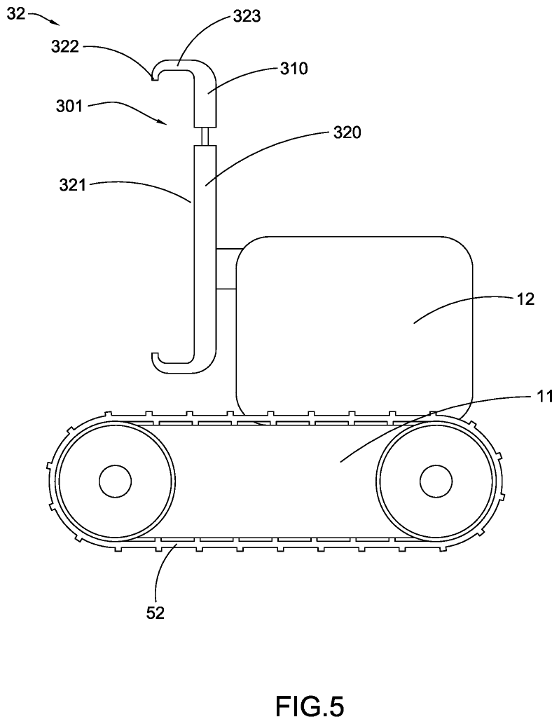

In some other embodiments of the present invention, the holding element 30 holds the phone 200 in a specific position by clamping. Accordingly, as shown in FIG. 5, the holding element 30 comprises a clamping element 32 which has a clamping space 301 for clamping the phone 200. Preferably, the clamping element 32 comprises at least one movable part 310, so that the clamping element 32 can switch between an open state and a closed state. When the clamping element 32 is in the open state, the opening of the clamping space 301 increases for the phone 200 to enter or exit from the opening of the clamping space 301. When the clamping element 32 is in the closed state, the opening of the clamping space 301 reduces, so that the phone 200 can be clamped inside the clamping space 301.

The specific structure of the clamping element 32 is not limited in the present invention. For example, in one embodiment of the present invention, the clamping element 32 comprises a clamping bottom wall 321, a clamping inward extending wall 322, and a clamping circumferential wall 323. The clamping bottom wall 321 and the clamping inward extending wall 322 are relatively and mutually spaced in the thickness direction of the clamping element 32. The clamping circumferential wall 323 is extended between the clamping bottom wall 321 and the clamping inward extending wall 322. The clamping inward extending wall 322 has an opening which is formed as an opening of the clamping space 301 of the clamping element 32. When the phone 200 is placed in the clamping space 301 of the clamping element 32, the back of the phone 200 faces the clamping bottom wall 321, the front of the phone 200 faces the opening of the clamping space 301, and the display screen of the phone 200 corresponds at least partially to the opening of the clamping space 301.

Alternatively, the clamping circumferential wall 323 can be extended from the outer peripheral edge of the clamping bottom wall 321 in the thickness direction of the clamping element 32; the clamping circumferential wall 323 can also be extended from other positions of the clamping bottom wall 321 in the thickness direction of the clamping element 32. For example, from a position inside the outer peripheral edge of the clamping bottom wall 321 in the thickness direction of the clamping element 32.

Optionally, the clamping circumferential wall 323 can surround the clamping bottom wall 321 in a complete circle in the circumferential direction, forming a ring-shaped clamping circumferential wall 323. For example, the clamping circumferential wall 323 is extended along the entire outer peripheral edge of the clamping bottom wall 321 in the thickness direction of the clamping element 32. The clamping circumferential wall 323 can also be partially set in the circumferential direction of the clamping bottom wall 321. For example, the clamping circumferential wall 323 is extended from the respective first and second sides of the clamping bottom wall 321 in the thickness direction of the clamping element 32 to form a first circumferential wall and a second circumferential wall. The clamping inward extending wall 322 comprises a first inward extending wall and a second inward extending wall. The first inward extending wall is extended inward from the first circumferential wall of the clamping circumferential wall 323, and the second inward extending wall is extended inward from the second circumferential wall of the clamping circumferential wall 323. The first inward extending wall and the second inward extending wall are opposite to each other and spaced apart from each other, and the spacing between the first inward extending wall and the second inward extending wall forms an opening of the clamping space 301.

In one example of this application, the clamping element 32 comprises a fixed part 320 and a movable part 310, and the movable part 310 is movably installed on one side of the fixed part 320. The fixed part 320 has a fixed cavity, and the movable part 310 has a deformable cavity, and the fixed cavity and the deformable cavity are opposite to each other, forming the clamping space 301. When the movable part 310 is moved away from the fixed part 320, the clamping space 301 is in an open state, the opening of the clamping space 301 increases, and it is suitable for the phone 200 to enter and exit from the opening of the clamping space 301. When the movable part 310 is moved towards the fixed part 320, the clamping element 32 is in a closed state, the size of the opening of the clamping space 301 is reduced, and it is suitable for clamping the phone 200 inside the clamping space 301.

In another example of this application, the clamping element 32 comprises a fixed part 320 and two movable parts 310, namely, a first movable part and a second movable part. The first movable part and the second movable part are located on opposite sides of the fixed part 320 and can be movably installed on the fixed part 320. When the first movable part and/or the second movable part move away from the fixed part 320, the clamping space 301 is in an open state, and the opening of the clamping space 301 increases, so that it is suitable for the phone 200 to enter or exit from the opening of the clamping space 301. When the first movable part and/or the second movable part move towards the fixed part 320, the clamping element 32 is in a closed state, and the size of the opening of the clamping space 301 is reduced, so that it is suitable for clamping the phone 200 inside the clamping space 301.

In another example of this application, the clamping element 32 comprises two movable parts 310, namely, the first movable part and the second movable part, and the first movable part and the second movable part are positioned opposite to each other. The first movable part has a cavity, and the second movable part has a cavity, and the cavity of the first movable part is positioned opposite to the cavity of the second movable part, forming a clamping space 301 of the clamping element 32. When the first movable part and the second movable part move away from each other, the clamping space 301 is in an open state, and the opening of the clamping space 301 increases, so that it is suitable for the phone 200 to enter or exit from the opening of the clamping space 301. When the first movable part and the second movable part move closer to each other, the clamping element 32 is in a closed state, and the size of the opening of the clamping space 301 is reduced, so that it is suitable for clamping the phone 200 inside the clamping space 301.

It should be understood that in other embodiments of this application, the specific structure of the clamping element 32 can be implemented in other ways.

Correspondingly, in some embodiments of the present invention, the phone holder 100 further comprises a first driving element, wherein the first driving element comprises a first driving motor, and the first driving motor is operatively connected to the movable part 310 of the clamping element 32, so that when the first driving motor rotates, it drives the movable part 310 of the clamping element 32 to move, thereby switching the clamping element 32 between the open state and the closed state. For example, when the first driving motor moves in the first driving direction, the first driving motor drives at least one movable part 310 of the clamping element 32 to move away from the fixed part 320, or drives at least two movable parts 310 of the clamping element 32 to move away from each other, so that the clamping element 32 opens and the opening of the clamping space 301 increases, facilitating the user to place the phone 200 in the clamping space 301 of the clamping element 32, or to remove the phone 200 from the clamping element 32. When the first driving motor moves in the second driving direction, the first driving motor drives at least one movable part 310 of the clamping element 32 to move towards the fixed part 320, or drives at least two movable parts 310 of the clamping element 32 to move towards each other, so that the clamping element 32 retracts and the size of the opening of the clamping space 301 is reduced.

Optionally, at least one elastic restore member can be provided between at least one movable part 310 and the fixed part 320, or at least one elastic restore member can be provided between the two movable parts 310, so that when the phone 200 is taken out from the clamping element 32, the elastic restore member drives the movable parts 310 to move, causing the clamping space 301 to automatically shrink.

Optionally, the first driving element further comprises a first transmission member, and the first transmission member is operatively connected between the first driving motor and the corresponding movable part 310 of the clamping element 32, so that the first driving motor is operatively connected to the corresponding movable part 310 of the clamping element 32 in this way.

The type of the first driving motor is not limited in this application. The first driving motor is communicatively connected to the holder controller 20, so that the holder controller 20 can control the first driving motor to switch between a working mode and a non-working mode. When the first driving motor is in the working mode, the first driving motor is in a motion state, and when the first driving motor is in the non-working mode, the first driving motor is in the non-motion state.

Optionally, the opening and closing of the clamping element 32 can be directly controlled by the phone holder 100, or the opening and closing of the clamping space 301 of the clamping element 32 of the phone holder 100 can be controlled by the phone 200. The specific implementation of the opening and closing of the clamping space 301 of the clamping element 32 of the phone holder 100 controlled by the phone 200 will be described in detail in the section on the interaction between the phone 200 and the phone holder 100 in the following description.

In the present embodiment of the present invention, the holding element 30 is movably installed on the installation base 10. Furthermore, the holding element 30 is movably installed on the installation base 10 by being pivotally mounted, allowing the holding element 30 to perform a pitch and tilt movements with respect to the installation base 10. When the holding element 30 rotates in a first direction, the holding element 30 pitches forward, when the holding element 30 rotates in a second direction, the holding element 30 pitches backward.

In the embodiment where the holding element 30 is implemented as the magnetic holding element 31, the side where the holding surface 3111 of the magnetic holding element 31 is located is set as a front side of the magnetic holding element 31, and the side where the opposite surface 3112 of the magnetic holding element 31 is located is set as a back side of the magnetic holding element 31. In the embodiment where the holding element 30 is implemented as the clamping element 32, the side where the clamping inward extending wall 322 of the clamping element 32 is located is set as the front side of the clamping element 32, and the side where the clamping bottom wall 321 of the clamping element 32 is located is set as the back side of the clamping element 32.

Correspondingly, in this embodiment of the present invention, the phone holder 100 further comprises a second driving mechanism 40 which is used to control the movement of the holding element 30. The specific implementation of the second driving mechanism 40 is not limited by the present invention. In one embodiment of the present invention, the second driving mechanism 40 comprises a second driving motor 41 which is operatively connected to the holding element 30, so that the second driving motor 41 can drive the movement of the holding element 30 during its operation. The second driving motor 41 can be implemented as a servo motor. The servo motor can not only drive the movement of the holding element 30, but also detect the rotation angle and rotation speed, so as to further detect whether the rotation angle reaches a specified angle or the rotation position reaches a specified position. Optionally, the second driving mechanism 40 further comprises a second transmission member which is operatively connected between the holding element 30 and the second driving motor 41 to achieve transmission between the holding element 30 and the second driving motor 41.

The second driving motor 41 is communicatively connected to the holder controller 20, so that the holder controller 20 can control the second driving motor 41 to switch between the working mode and the non-working mode. When the second driving motor 41 is in the working mode, it is in motion, and when the second driving motor 41 is in non-working mode, it is in the non-motion state.

In this embodiment of the present invention, the phone 200 and the phone holder 100 can interact with each other, and the pitch and tilt of the holding element 30 of the phone holder 100 can be controlled by the phone 200. The specific implementation of controlling the pitch and tilt of the holding element 30 of the phone holder 100 by the phone 200 will be described in more detail in the section introducing the interaction mode between the phone 200 and the phone holder 100 in the following description.

In this embodiment of the present invention, the phone holder 100 further comprises a third driving mechanism 50 installed on the installation base 10 to achieve the mobility of the phone holder 100. The specific structure of the third driving mechanism 50 is not limited by the present invention. In this embodiment of the present invention, the third driving mechanism 50 comprises a third driving motor 51 and at least one moving element 52. The moving element 52 is movably installed on the installation base 10 and is operatively installed on the driving motor, so that when the third driving motor 51 rotates, it drives the moving element 52 to move, thereby achieving the movement of the installation base 10 of the phone holder 100 through the moving element 52, and further realizing the movement of the entire phone holder 100, e.g. “forward”, “backward”, “left turn”, and “right turn”. In this embodiment of the present invention, the front side of the holding element 30 is the front side of the phone holder 100, and the rear side of the holding element 31 is the rear side of the phone holder 100. The left side of the phone holder 100 in FIG. 2 of the specification is the left side, and the right side of the phone holder 100 in FIG. 2 of the specification is the right side. When the phone holder 100 moves towards its front side, the phone holder 100 moves forward, and when the phone holder 100 moves towards its rear side, the phone holder 100 moves backward.

The embodiments of the driving motor and the moving elements 52 are not limited to the present invention. For example, the driving motor can be implemented as an encoder motor or other types of motors. The moving element 52 can be installed on the base portion 11 of the installation base 10 and can be implemented as a roller, a caterpillar, or other types of moving components 52. In this way, the phone holder 100 can provide mobility and allow tangible interactions between the intelligent interactive system used for the interactive phone holder and the user, so as to enhance and widen the interactive dimensions of the phone 200. The phone holder 100 can benefit from its mobility and may be used as a remote control car.

The third driving motor 51 is communicatively connected to the holder controller 20, allowing the holder controller 20 to control the third driving motor 51 to switch between the working mode and the non-working mode. When the third driving motor 51 is in the working mode, it is in a moving state, and when the third driving motor 51 is in the non-working mode, it is in a non-moving state.

The specific implementation of controlling the movement of the phone holder 100 by the phone 200 will be described in more detail in the section introducing the interaction mode between the phone 200 and the phone holder 100 in the following description.

In this embodiment of the present invention, the phone holder 100 further comprises at least one cliff sensor 60. The cliff sensor 60 is installed at the bottom of the installation base 10 to detect the distance between the bottom of the phone holder 100 and an object below the phone holder 100. Specifically, the number of cliff sensors 60 is not limited in this application. For example, in one example of this application, the number of cliff sensors 60 is four the four cliff sensors 60 are symmetrically distributed. It should be understood that the number of cliff sensors 60 can be 1, 2, 3, or other values. The cliff sensor 60 can be set at the bottom of the base portion 11. The cliff sensor 60 can be implemented as an infrared ranging sensor. The cliff sensor 60 comprises a signal transmitting end and a signal receiving end. The signal transmitting end emits detection light (e.g., infrared light), and if the signal receiving end does not receive a reflected signal within a preset time, it determines that the distance between the bottom of the phone holder 100 and the object below the phone holder 100 is far from a value allowing the phone holder 100 to stand normally, and the distance between the bottom of the phone holder 100 and the object below the phone holder 100 exceeds a first preset distance.

The cliff sensor 60 is communicatively connected to the holder controller 20, so that the cliff sensor 60 can transmit the data of the distance between the bottom of the phone holder 100 and the object below the phone holder 100 to the holder controller 20.

The holder controller 20 of the phone holder 100 can control the phone holder 100 to stop moving forward based on the data of the distance between the bottom of the phone holder 100 and the object below the phone holder 100, which can prevent the phone holder 100 from falling. Alternatively, the phone holder 100 can transmit the data of the distance between the bottom of the phone holder 100 and the object below the phone holder 100 to the phone 200, and the phone 200 controls the phone holder 100 to stop moving forward.

In this embodiment of the present invention, the phone holder 100 further comprises an obstacle avoidance sensor 70, which can be implemented as an infrared ranging sensor. The obstacle avoidance sensor 70 is located at the front of the phone holder 100, specifically installed on the front of the installation base 10 or the holding element 30, for detecting the distance between the front of the phone holder 100 and an object in front of the phone holder 100. When the distance between the front of the phone holder 100 and the object in front of the phone holder 100 is less than a second preset distance, it is determined that there is an obstacle in front of the phone holder 100.

The obstacle avoidance sensor 70 is communicatively connected to the holder controller 20, so that the obstacle avoidance sensor 70 can transmit the data of the distance between the front of the phone holder 100 and the object in front of the phone holder 100 to the holder controller 20.

The holder controller 20 of the phone holder 100 can control the phone holder 100 to stop moving forward based on the data of the distance between the bottom of the phone holder 100 and the object in front of the phone holder 100, which can avoid the phone holder 100 from colliding with obstacles. Alternatively, the phone holder 100 transmits the distance data between the bottom of the phone holder 100 and the object in front of the phone holder 100 to the phone 200, and the phone 200 controls the phone holder 100 to stop moving forward.

Optionally, in this embodiment of the present invention, the phone holder 100 further comprises a proximity detection sensor which can be implemented as an infrared ranging sensor. The proximity detection sensor is located at the front of the phone holder 100, specifically installed on the front side of the holding element 30 or the front side of the installation base 10 adjacent to the holding element 30 of the phone holder 100 for detecting the distance between the holding element 30 of the phone holder 100 and the target object (e.g., any phone 200 or a phone 200 with a specific identifier). When the distance between the holding element 30 of the phone holder 100 and the target object is detected to be less than a third predetermined distance, it is determined that the target object is approaching the holding element 30 of the phone holder 100.

The proximity detection sensor is communicatively connected to the holder controller 20, so that the proximity detection sensor can transmit the data of the distance between the holding element 30 of the phone holder 100 and the target object to the holder controller 20.

Optionally, when the holding element 30 of the phone holder 100 is implemented as a clamping element 32, the holder controller 20 of the phone holder 100 can control the clamping element 32 of the phone holder 100 to open based on the data of the distance between the clamping element 32 of the phone holder 100 and the target object. When the proximity detection sensor of the phone holder 100 detects that the distance between the clamping element 32 and the target phone 200 is less than the third preset distance, the holder controller 20 of the phone holder 100 controls the first driving motor to move in the first driving direction, causing at least one movable part 310 of the clamping element 32 to move away from the fixed part 320, or causing at least two movable parts 310 of the clamping element 32 to move away from each other, thereby opening the clamping element 32. Similarly, when the phone 200 approaches the clamping element 32 of the phone holder 100, the holder controller 20 of the phone holder 100 controls the clamping element 32 to open.

The phone holder 100 can also transmit the data of the distance between the clamping element 32 of the phone holder 100 and the target object to the phone 200, and the phone 200 controls the clamping element 32 of the phone holder 100 to open.

Optionally, the phone holder 100 further comprises a TOF distance sensor 80 for measuring the distance between the phone holder 100 and the target object. Furthermore, optionally, the TOF distance sensor 80 is located at the front of the phone holder 100, specifically, installed on the front side of the holding element 30 or the front side of the installation base 10.

The proximity detection sensor is communicatively connected to the holder controller 20, allowing the proximity detection sensor to transmit the data of the distance between the holding element 30 of the phone holder 100 and the target object to the holder controller 20.

Optionally, in this embodiment of the present invention, the phone holder 100 further comprises a touch sensor positioned on the holding element 30 or the installation base 10. The touch sensor can be implemented as a pressure sensor which determines if it is touched when a pressure value exceeds a predetermined value. The touch sensor can also be implemented as other types of sensors, such as infrared sensors, spectral sensors, etc. When the infrared sensor detects that it is blocked or the distance between it and the object in front of it is less than a predetermined value, it determines that it is touched. The touch sensor of the phone holder 100 can also be implemented as a capacitive touch sensor.

The touch sensor is communicatively connected to the holder controller 20, so that the touch sensor can transmit the sensed data to the holder controller 20.

The holder controller 20 of the phone holder 100 can control the clamping element 32 of the phone holder 100 to open based on the sensed data of the touch sensor. When the touch sensor of the phone holder 100 detects a touch, the holder controller 20 of the phone holder 100 controls the first driving motor to move in the first driving direction, causing at least one movable part 310 of the clamping element 32 to move away from the fixed part 320, or causing at least two movable parts 310 of the clamping element 32 to move away from each other, thereby opening the clamping element 32. Similarly, when the user touches the touch sensor of the phone holder 100, the holder controller 20 of the phone holder 100 controls the clamping element 32 to open.

The phone holder 100 can also transmit the sensed data of the touch sensor to the phone 200, and the phone 200 controls the clamping element 32 of the phone holder 100 to open.

In this embodiment of the present invention, the phone holder 100 further comprises a power component 90. The power component 90 comprises at least one primary power source 91 which is used to power various components of the phone holder 100, and the primary power source 91 is electrically connected to the holder controller 20. The primary power source 91 can be implemented as a lithium battery or other types of batteries.

The power component 90 further comprises at least one charging element 92 which can be implemented as a wireless charging element 92 to achieve wireless charging for the phone 200. When the holding element 30 is implemented as a magnetic holding element 31, the wireless charging element 92 is implemented on the holding surface 3111 of the magnetic holding element 31.

When the holding element 30 is implemented as the clamping element 32, the wireless charging element 92 can be placed on the clamping bottom wall 321 of the clamping element 32. When the phone 200 is placed in the clamping element 32 of the phone holder 100 with the back of the phone 200 facing the clamping bottom wall 321, it corresponds to the wireless charging element 92, achieving wireless connection with the wireless charging element 92 and thus enabling wireless charging. It should be understood that the wireless charging element 92 can also be placed at other positions of the phone holder 100. It should also be understood that the charging element 92 can be implemented as a wired charging element 92. Optionally, the charging element 92 is electrically connected to the primary power source 91 to obtain electrical energy from the primary power source 91, or it can be disconnected from the primary power source 91 and obtain electrical energy from an external power source.

The power component 90 further comprises a power management module 93 electrically connected to the primary power source 91 to control the charging and discharging process of the primary power source 91, ensuring the safety and stability of the charging and discharging of the primary power source 91.

In this embodiment of the present invention, the phone holder 100 further comprises at least one information indicator light 102 which is communicatively connected to the holder controller 20 to display the status of the phone holder 100, such as the connection status and battery information of the phone holder 100.

The number and arrangement of the information indicator lights 102 are not limited in the present invention. In some embodiments of the present invention, the phone holder 100 comprises a plurality of information indicator lights 102, and the plurality of information indicator lights 102 is connected in parallel to each other. The plurality of information indicator lights 102 can be arranged in multiple columns, and each column of information indicator lights 102 may include multiple information indicator lights 102.

Optionally, the present invention further comprises a light diffuser placed in the light emission path of the plurality of information indicator lights 102. Each column of the information indicator lights 102 forms a light strip which is provided with a corresponding light diffuser.

The plurality of information indicator lights 102 can cooperate with each other to form different working modes, such as continuous, flashing, gradient, left sweep, right sweep, center diffusion, etc.

Specifically, in the continuous working mode, the information indicator lights 102 behave as follows: within a first preset time, the information indicator lights 102 maintain the same light color and remain in the on state; in the flashing working mode, within a second preset time, the information indicator lights 102 switch between two light colors or switches between the on state and the off state; in the gradient working mode, within a third preset time, the information indicator lights 102 gradually switch from one light color to another light color in a time-interpolated manner, and the light color continuously changes during the process of switching from one light color to another; in the left sweep working mode, the plurality of information indicator lights 102 transition from one light color to another from left to right; in the right sweep working mode, the plurality of information indicator lights 102 transition from one light color to another from right to left; in the center diffusion working mode, the plurality of information indicator lights 102 transition from one light color to another from the information indicator light 102 located in the center to the information indicator light 102 located on the periphery.

In the three lighting modes of left sweep, right sweep, and center diffusion, during the process of color change of the lights, there are three light color states for each information indicator light 102: the light color is the initial color, the light color is the target color, and the light color is in the transition color between the initial color and the target color, and the transition color is determined by time interpolation.

In this embodiment of the present invention, the phone holder 100 further comprises at least one illumination light 101. In this embodiment of the present invention, the holder controller 20 of the phone holder 100 can control the opening and closing of the illumination light 101 based on the ambient brightness, or the phone 200 can control the opening and closing of the illumination light 101 based on the ambient brightness.

The number and arrangement of the illumination lights 101 are not limited in the present invention. In some embodiments of the present invention, the phone holder 100 comprises a plurality of illumination lights 101, and at least one illumination light 101 is set on the left side of the installation base 10, and at least one illumination light 101 is set on the right side of the installation base 10.

Optionally, in this embodiment of the present invention, the phone holder 100 further comprises at least one operating element which is communicatively connected to the holder controller 20. The operating element is used for user operation to control the phone holder 100 or interact with the phone 200. The specific structure of the operating element is not limited by the present invention. For example, the operating element can be implemented as a touch key, mechanical button, joystick, etc. The implementation of the operating element's working mode is also not limited by the present invention. For example, when the operating element is implemented as a touch key, clicking the touch key controls the phone holder 100 to start working; double-clicking the touch key controls the phone holder 100 to communicatively connect with the phone 200 and trigger the opening of a specific APP on the phone 200, achieving interaction between the phone holder 100 and the phone 200; long-pressing the touch key controls the phone holder 100 to communicatively connect with the phone 200 and trigger the follow-up function of the phone 200, achieving interaction between the phone holder 100 and the phone 200.

Optionally, the control of the phone holder 100 can be achieved through an operating element of the phone 200, thereby achieving interaction between the phone 200 and the phone holder 100. For example, the power button, volume control button, and other operating element of the phone 200 can be used to control the phone holder 100.

In this embodiment of the present invention, the phone 200 comprises a display screen for displaying image information, such as expressions, video portraits during calls, and the running status of APPs.

The phone 200 further comprises a phone accelerometer installed on the phone body to test the three-axis acceleration of the phone 200 during motion. For example, when the phone 200 rotates, the phone accelerometer can detect the rotation direction and acceleration of the phone 200; when the phone 200 shakes, the phone accelerometer can detect the acceleration of the phone 200 during the shake, which can be used for game control, photography, screenshot, step counting, etc. The phone accelerometer can determine whether the phone 200 is collided, overturned, or picked up, and can also determine the pose of the phone 200. The pose of the phone 200 refers to the position and gesture of the phone 200, including translation data and rotation data in multiple directions. The phone accelerometer can cooperate with the phone holder 100 to determine whether the phone 200 and the phone holder 100 can be connected in a communicable manner.

The phone 200 further comprises a phone accelerometer and an electronic compass installed on the phone body, and the phone accelerometer can be used to test the angular velocity of the phone 200 during motion.

The phone 200 further comprises a camera installed on the phone body to capture images of a target object. Furthermore, the camera can be used to identify the target object, such as a cup, a mouse, a potted plant, a face, or a gesture. The camera can be used as the “eye” of the phone 200 and the phone holder 100, so as to work together to achieve facial tracking. Additionally, the camera can capture images of the surrounding environment for mapping.

The phone 200 also comprises a microphone installed on the phone body to receive sound signals. The voice recognition algorithm can work together with the microphone to identify the received sound signals and convert them into text.

The phone 200 further comprises a light sensor installed on the phone body to perceive the brightness of the light in the surrounding environment.

The phone 200 serves as the central processing and control unit for information processing, and can control the operation mode of the phone holder 100. The user can manipulate the phone 200 and control the phone holder 100 through the phone 200, achieving interaction with the phone holder 100. For example, the phone holder 100 can be controlled to move through a phone app. It is worth mentioning that the controller of the phone 200 has a higher computing power, which can reduce the computing burden on the controller of the phone holder 100. The user can also directly operate the phone holder 100 to interact with it, for example, by touching a specific position on the phone holder 100 to open the clamping element 32 of the phone holder 100. The user can still interact with the phone 200 through conventional methods such as touch screen, voice, vision, and buttons, and the functions of the phone 200 and its interaction with the user remain unchanged.

The interaction between the phone 200 and the phone holder 100 is not limited to this application. The interaction between the phone 200 and the phone holder 100 can be achieved through a specific APP on the phone 200. The display screen of the phone 200 can display the user interface of the APP. In terms of control signal triggering mechanism, the control instructions of the phone 200 to the phone holder 100 can be triggered through the user interface, voice, gestures, touch keys, mechanical buttons, etc. of the APP, so that the phone 200 can send control signals to the phone holder 100. After receiving the control signals from the phone 200, the phone holder 100 can interact based on the control signals. The control instructions of the phone 200 to the phone holder 100 can also be triggered by the sensor data transmitted by the phone holder 100, so that the phone 200 can send control signals to the phone holder 100. After receiving the control signals from the phone 200, the phone holder 100 can interact based on the control signals.

In terms of interactive content, optionally, it can be determined whether the phone 200 is magnetically connected to the phone holder 100; the clamping element 32 of the phone holder 100 can be controlled to open and close by the phone 200; the phone holder 100 and the phone 200 can be cooperatively used for emotional expression by the phone 200; during the process of emotional expression by the phone holder 100 and the phone 200, the phone 200 can control the display of emoticons or emoticon animations on the phone 200, control the pitching movement of the holding element 30 of the phone holder 100, control the overall movement of the phone holder 100, and adjust the status of the information indicator light of the phone holder 100; the phone 200 can control the face tracking of the phone holder 100; physical video chat interaction can be achieved by controlling the phone holder 100 with the phone 200; mapping and path planning can be achieved by the cooperation of the phone 200 and the phone holder 100; the opening and closing of the illumination light 101 of the phone holder 100 can be controlled by the phone 200; the phone 200 can determine the power information of the phone holder 100 through the sensing signal of the phone holder 100.

In the interaction of determining whether the phone 200 is magnetically connected to the phone holder 100 through the phone 200, the hall sensor 313 of the magnetic holding element 31 sends hall sensor data to the holder controller 20 of the phone holder 100. The holder controller 20 of the phone holder 100 forwards the hall sensor data to the phone 200. The phone 200 determines whether the phone holder 100 and the phone 200 are magnetically connected based on the hall sensor data. Alternatively, in the interaction of determining whether the phone 200 is magnetically connected to the phone holder 100 through the phone 200, the hall sensor 313 of the magnetic holding element 31 sends hall sensor data to the holder controller 20 of the phone holder 100. The holder controller 20 of the phone holder 100 determines whether the phone holder 100 and the phone 200 are successfully magnetically connected based on the hall sensor data. When the phone holder 100 determines that the phone 200 is magnetically connected to the phone holder 100, the phone holder 100 sends a first signal to the phone 200, and the phone 200 confirms that it is magnetically connected to the phone holder 100. When the phone 200 does not receive the first signal, the phone 200 determines that it is not magnetically connected to the phone holder 100.

As described above, when the phone 200 is close to the phone holder 100 and subsequently held on the phone holder 100 through magnetic attraction, the hall sensor 313 of the magnetic holding element 31 can sense changes in the magnetic field around it. Accordingly, when the phone 200 detects changes in the hall sensor data and the range of change exceeds a preset threshold, it is determined that the phone 200 is magnetically connected to the phone holder 100.

In the interaction of controlling the clamping element 32 of the phone holder 100 through the phone 200, optionally, the phone 200 can be triggered to send control instructions to the phone holder 100 through the user interface, voice, gestures, touch keys, mechanical buttons, etc. of the APP, so that the phone 200 sends control signals to the phone holder 100 to control the opening and closing of the clamping element 32 of the phone holder 100. For example, the user clicks on a specific virtual button (e.g., “key for opening the clamp of the phone holder”) on the user interface of the APP, or sends a specific voice signal (e.g., signal of “open the clamp of the phone holder”) to the phone 200, or presses a specific touch key a preset number of times or for a preset time, or presses a specific mechanical button a preset number of times or for a preset time, or triggers the phone 200 to send control instructions to the phone holder 100 in other ways, so that the phone 200 sends control signals to the phone holder 100 to control the opening and closing of the clamping element 32 of the phone holder 100.

In the interaction of controlling the opening and closing of the clamping element 32 of the phone holder 100 through the phone 200, optionally, the phone 200 can trigger control instructions to the phone holder 100 based on the sensing signals feedback by the phone holder 100, so that the phone 200 sends control signals to the phone holder 100 to control the opening and closing of the clamping element 32 of the phone holder 100.

Specifically, in one embodiment of the present invention, after the phone holder 100 and the target phone 200 are communicatively connected, the phone holder 100 transmits the data of the distance between the clamping element 32 of the phone holder 100 detected by the proximity detection sensor and the target phone 200 to the phone 200. The phone 200 compares the data of the distance between the clamping element 32 of the phone holder 100 detected by the proximity detection sensor and the target phone 200 with a third preset distance, and in response to the distance data being less than the third preset distance, determines that the clamping element 32 of the target phone 200 is close to the phone holder 100, and sends a control signal to the phone holder 100 to control the first driving motor of the phone holder 100 to move in the first driving direction, causing at least one movable part 310 of the clamping element 32 driven by the first driving motor to move away from the fixed part 320, or causing at least two movable parts 310 of the clamping element 32 to move away from each other, thereby opening the clamping element 32. In this way, when the phone 200 is close to the phone holder 100, the clamping element 32 of the phone holder 100 opens, making it easier for the user to clamp the phone 200 with the clamping element 32 of the phone holder 100.

In another embodiment of the present invention, after the phone holder 100 and the target phone 200 are communicatively connected, the phone holder 100 transmits the sensing data detected by its touch sensor to the phone 200. Based on the sensing data detected by the touch sensor, the phone 200 determines whether the touch sensor is touched. When the phone 200 determines that the touch sensor is touched, it sends a control signal to the phone holder 100, controlling the first driving motor of the phone holder 100 to move in the first driving direction, causing at least one movable part 310 of the clamping element 32 driven by the first driving motor to move away from the fixed part 320, or causing at least two movable parts 310 of the clamping element 32 to move away from each other. As a result, the clamping element 32 opens when the user touches the position of the touch sensor, making it easier for the user to clamp the phone 200 with the clamping element 32 of the phone holder 100.

During the process of emotional expression coordinated between the phone holder 100 and the phone 200 controlled by the phone 200, the phone 200 is communicatively connected to the phone holder 100. After generating a control signal, the phone 200 and the phone holder 100 cooperate with each other based on the control signal to perform the corresponding emotional expression group and achieve emotional expression.

The phone 200 and the phone holder 100 cooperate with each other to perform corresponding emotional expression groups, comprising: the phone 200 displaying at least one expression pattern or expression animation, the phone holder 100 performing at least one basic action, and the phone holder 100 adjusting the state of one or more information indicator lights 102.

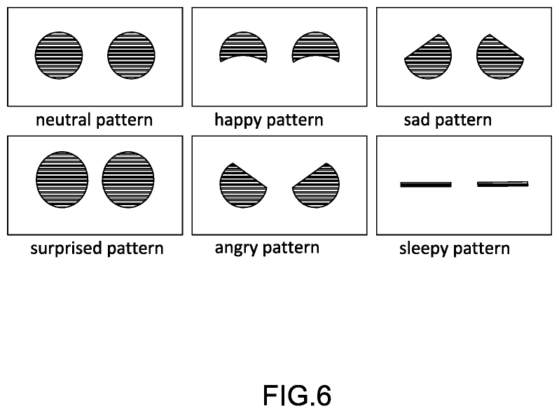

The expression patterns comprise neutral patterns, happy patterns, sad patterns, surprised patterns, angry patterns, sleepy patterns, and disdain patterns. It is worth mentioning that when multiple expression patterns are switching, an expression animation will be formed. The expression animations comprise photo-taking animation, listening animation, right-looking animation, angry animation, surprised animation, disdain animation, and so on. The implementation of the expression patterns and expression animations is not limited by this application. For example, as shown in FIG. 6, the sleepy pattern can be represented by two line segments, which are on the same straight line and spaced apart from each other. The sleepy pattern can also be represented in other ways.

The basic movements comprises forward, backward, left turn, right turn, forward tilt, and backward tilt. At least two combinations of forward, backward, left turn, right turn, forward tilt, and backward tilt can form a sequence of movements. When the phone holder 100 performs the forward basic movement, the phone holder 100 as a whole moves forward; when the phone holder 100 performs the backward basic movement, the phone holder 100 as a whole moves backward; when the phone holder 100 performs the left turn basic movement, the phone holder 100 as a whole turns left; when the phone holder 100 performs the right turn basic movement, the phone holder 100 as a whole turns right; when the phone holder 100 performs the forward tilt movement, the suspension part of the phone holder 100 rotates forward; when the phone holder 100 performs the backward tilt basic movement, the holding element 30 of the phone holder 100 rotates backward.

When the information indicator lights 102 are in a continuous state, within the first preset time, the information indicator lights 102 maintain the same light color and remain in the illuminated state; when the information indicator lights 102 are in a flashing state, within the second preset time, the information indicator lights 102 switch between two light colors or switches between the illuminated state and the off state; when the information indicator lights 102 are in a gradient state, within the third preset time, the information indicator lights 102 gradually switch from one light color to another light color in a time difference manner; when the information indicator lights 102 are in a left sweep state, the plurality of information indicator lights 102 transition from one light color to another light color from left to right; when the information indicator lights 102 are in a right sweep state, multiple information indicator lights 102 transition from one light color to another light color from right to left; when the information indicator lights 102 are in a center diffusion state, the plurality of information indicator lights 102 transition from one light color to another light color from the information indicator light 102 located in the center to the information indicator light 102 located on the periphery.

Specifically, in the process of generating the control signal by the phone 200, the control instruction of the phone 200 to the phone holder 100 can be triggered by the sensor data of the phone 200. For example, the control instruction of the phone 200 to the phone holder 100 can be triggered by the sensor data of the APP's user interface, voice sensor data, gesture sensor data, touch key sensor data, mechanical key sensor data, etc. The phone 200 sends the control signal to the phone holder 100. The control instruction of the phone 200 to the phone holder 100 can also be triggered by the sensor data of the phone holder 100. The control instruction of the phone 200 to the phone holder 100 can be triggered by the sensor data of the phone 200 and the sensor data of the phone holder 100 together.

In the process of triggering the control instruction of the phone 200 to the phone holder 100 by the sensor data of the phone holder 100, first, the sensor of the phone holder 100 generates sensing data. Then, the holder controller 20 of the phone holder 100 sends a signal to the phone 200 based on the sensing data. Subsequently, the phone 200 generates the control signal based on the signal sent by the phone holder 100. Specifically, the sensor of the phone holder 100 comprises the cliff sensor 60, the obstacle avoidance sensor 70, the TOF distance sensor 80, and the touch sensor, etc.

For example, in one embodiment of the present invention, during the process of triggering the control command of the phone 200 to the phone holder 100 through the sensor's sensing data of the phone holder 100, first, the cliff sensor 60 of the phone holder 100 located at the front of the phone holder 100 generates cliff distance sensing data, and the data of the cliff distance sensing data is within the preset cliff sensing distance range, which means that the phone holder 100 has a risk of falling; then, the holder controller 20 of the phone holder 100 sends a signal to the phone 200 based on the cliff distance sensing data; subsequently, the phone 200 generates the control signal based on the signal sent by the phone holder 100.

Subsequently, in the process of executing the corresponding emotional expression group based on the control signal, the phone 200 and the phone holder 100 cooperate with each other to execute the “cliff-front cliff” emotional expression group. Specifically, the phone 200 displays a “surprised” animation (as shown in FIG. 8), and the phone holder 100 performs a “cliff avoidance” action sequence, which comprises: first, retreating, then turning left at a preset angle, and the preset angle can be implemented as 150 degrees or other values.

For example, in another embodiment of the present invention, during the process of triggering the control command of the phone 200 to the phone holder 100 through the sensor's sensing data of the phone holder 100, first, the obstacle avoidance sensor 70 located at the left front of the phone holder 100 generates obstacle avoidance distance sensing data, and the obstacle avoidance distance sensing data is within the preset obstacle avoidance distance range, indicating that there is an obstacle in the left front of the phone holder 100; then, the holder controller 20 of the phone holder 100 sends a signal to the phone 200 based on the obstacle avoidance distance sensing data; subsequently, the phone 200 generates the control signal based on the signal sent by the phone holder 100.

Subsequently, in the process of executing the corresponding emotional expression group based on the control signal, the phone 200 and the phone holder 100 cooperate with each other to execute the “obstacle-left front obstacle” emotional expression group. Specifically, the phone holder 100 performs the “avoid obstacle” action sequence, and the “avoid cliff” action sequence comprises: first retreat, then turn right at a preset angle, and then move forward. The preset angle can be implemented as 120 degrees or other values.

For example, in some embodiments of the present invention, in the process of triggering the control command of the phone holder 100 by the sensor's sensing data of the phone holder 100, first, the touch sensor of the phone holder 100 generates touch sensing data, and the touch sensing data is within the preset touch sensing range, which means that the phone holder 100 is touched; then, the holder controller 20 of the phone holder 100 sends a signal to the phone 200 based on the touch sensing data; subsequently, the phone 200 generates the control signal based on the signal sent by the phone holder 100.

In the subsequent process of executing the corresponding emotional expression group based on the control signal, the phone 200 and the phone holder 100 cooperate with each other to perform the “look right-turn right” emotional expression group. Specifically, the phone 200 displays the “look right” animation (as shown in FIG. 12), and the phone holder 100 performs the “turn right” action.

In the process of triggering the control command of the phone holder 100 by the sensing data of the phone 200, first, at least one sensor of the phone 200 generates sensing data; then, the phone 200 generates the control command based on the sensing data of the phone 200. Specifically, the sensors of the phone holder 100 comprise phone acceleration sensors, phone acceleration sensors, phone acceleration sensors, and cameras.

For example, in some embodiments of the present invention, in the process of triggering the control command of the phone holder 100 by the phone 200 through sensing data, first, the acceleration sensor of the phone 200 generates acceleration data, wherein the acceleration data exceeds a preset acceleration threshold, indicating that the phone 200 may be impacted. However, the phone 200 does not perform impact detection program. Then, the phone 200 generates the control command.

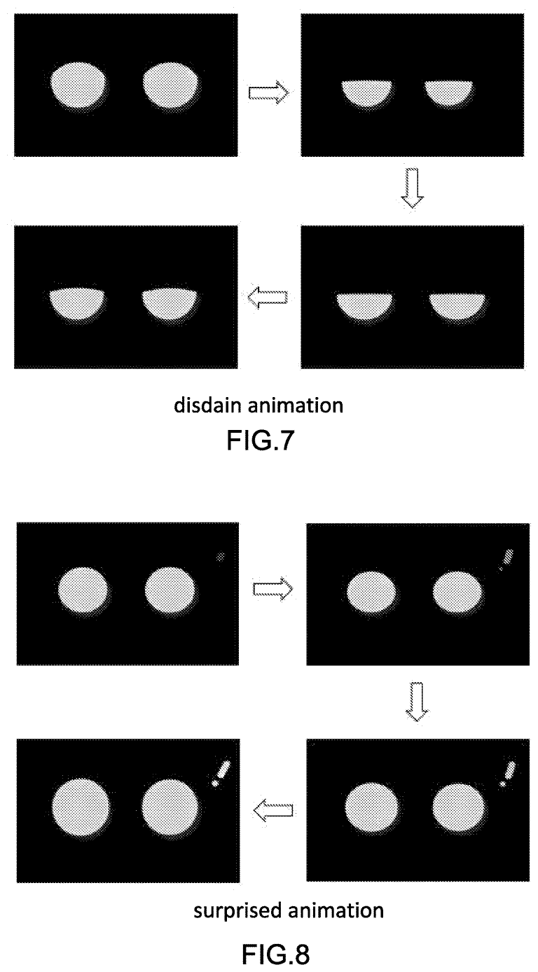

Subsequently, in the process of executing the corresponding emotional expression group based on the control signal, the phone 200 and the phone holder 100 cooperate with each other to perform the “surprise-disdain” emotional expression group. Specifically, the phone 200 first displays the “surprise” animation (as shown in FIG. 8), and then displays the “disdain” animation (as shown in FIG. 7). The phone holder 100 performs the “surprise-disdain” action sequence, which comprises moving back a preset first distance, then tilting back a preset first angle, then moving forward a preset second distance, and then tilting forward a preset second angle. The preset first distance may be equal to or different from the preset second distance, and the preset first angle may be equal to or different from the preset second angle.

For example, in some other embodiments of the present invention, in the process of triggering the control command of the phone holder 100 by the phone 200 through the sensing data, first, the camera of the phone 200 captures an image and the image processing module identifies two or more faces in the image; then, the phone 200 generates the control command based on the image from the camera.

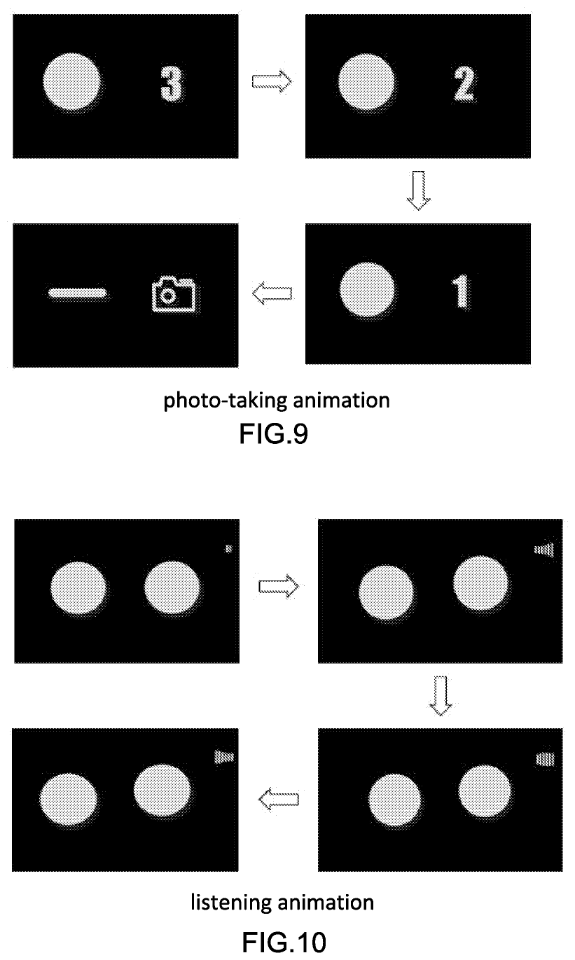

Subsequently, based on the control signal, the phone 200 and the phone holder 100 cooperate with each other to perform the corresponding emotional expression group. Specifically, the phone 200 displays a “taking group photo” animation (as shown in FIG. 9), the “taking photo” animation can be implemented as an animation where the left eye turns into a countdown interface and the camera flashes. The phone holder 100 performs a “aligning the face” action sequence, the “aligning the face” action sequence is implemented as an action sequence aligning the center position of two or more faces.

For example, in some other embodiments of the present invention, in the process of triggering the control command of the phone holder 100 by the sensing data of the phone 200, first, the microphone of the phone 200 captures the sound signal and the sound signal is recognized by the corresponding data processing module to identify the preset wake-up word in the sound signal, for example, “Hi, Xiao Yu” ; then, the phone 200 generates the control command based on the sound signal of the microphone.

In the subsequent process of executing the corresponding emotional expression group, the phone 200 and the phone holder 100 cooperate with each other based on the control signal. Specifically, the phone 200 displays a “listening” animation (as shown in FIG. 10), and the information indicator lights 102 of the phone holder 100 are adjusted to a center diffusion state, for example, the white center diffusion state is changed to a blue center diffusion state.

During the process of jointly triggering the control command of the phone 200 to the phone holder 100 through the sensing data of the phone 200 and the sensing data of the phone holder 100, first, the phone 200 generates at least one control signal, comprising: first, at least one sensor of the phone 200 generates sensing data, and at least one sensor of the phone holder 100 generates sensing data; then, the phone holder 100 sends a signal to the phone 200 based on the sensing data generated by its sensor; then, the phone 200 generates the control signal based on the sensing data generated by the sensor of the phone 200 and the signal sent by the phone holder 100.

For example, in some embodiments of the present invention, the third driving motor 51 of the phone holder 100 generates rotation sensing data, and the phone holder 100 sends a signal to the phone 200 based on the sensing data generated by the third driving motor 51. However, the sensing data of the phone accelerometer is less than or equal to the preset angular velocity threshold, and the phone 200 generates the control signal.

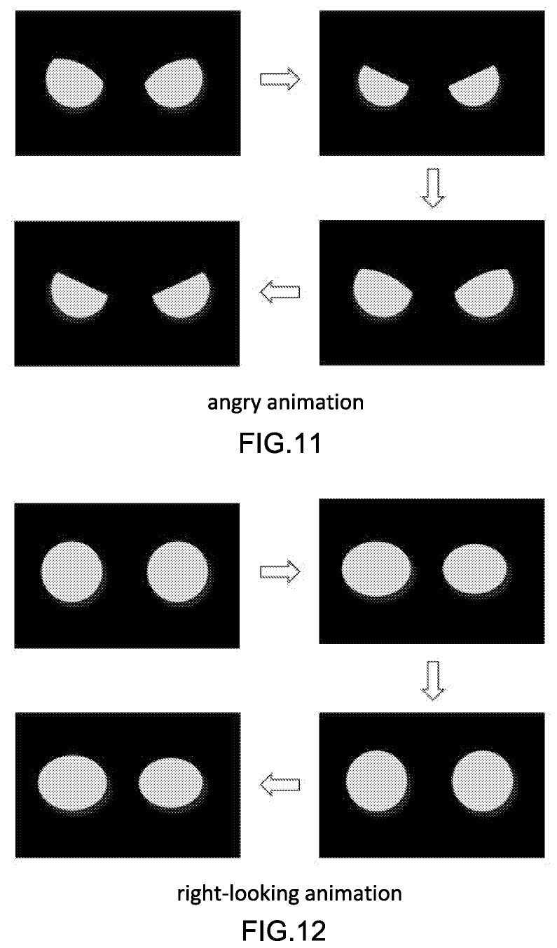

In the subsequent process of executing the corresponding emotional expression group, the phone 200 and the phone holder 100 cooperate with each other based on the control signal. Specifically, the phone 200 displays an “angry” animation (as shown in FIG. 11), and the phone holder 100 performs a “release” action sequence. The “release” action sequence comprises repeatedly turning left, turning right, and repeatedly moving forward and backward.

It is worth mentioning that the emoticon patterns and emoticon animations shown in the drawings are only one embodiment, and the specific implementation of emoticon patterns and emoticon animations is not limited to this application. For example, the “sad” emoticon pattern can be of other types. The implementation of the action sequence described in the specification is also only an example. For example, the “avoiding cliffs” action sequence can be formed by combining other basic actions.

It is also worth mentioning that in the interactive process of emotional expression between the phone holder 100 and the phone 200 controlled by the phone 200, the intelligent interactive system for the interactive phone holder performs emotional expression from multiple dimensions such as images, physical dynamics, and lighting through various means such as emoticon patterns, phone holder 100 movement modes, phone 200 pitching modes, and indicator light display modes. It greatly improves the humanization of the intelligent interactive system for the interactive phone holder, making the emotional expression of the intelligent interactive system for the interactive phone holder more vivid and natural.

In the interactive process of face tracking with the phone holder 100 controlled by the phone 200, optionally, the control instructions for the phone holder 100 by the phone 200 can be triggered through the user interface, voice, gestures, touch keys, mechanical buttons, etc. of the APP, so that the phone 200 sends control signals to the phone holder 100 to control the face tracking of the phone holder 100.

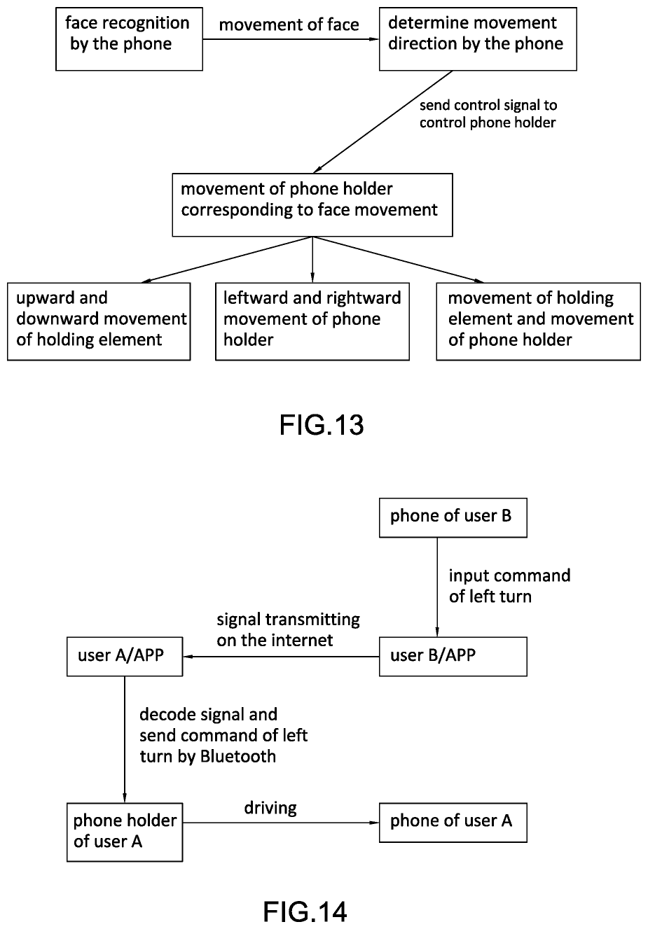

Specifically, as shown in FIG. 13, first, the phone 200 is held on the phone holder 100, then, face recognition is performed through the camera of the phone 200, then, when the phone 200 recognizes the target face, the position relationship between the target face and the phone 200 is obtained, and then, based on the position relationship between the target face and the phone 200, control signals are sent to the phone holder 100, and the control signals are used to control the overall movement of the phone holder 100 and/or the movement of the holding element 30 of the phone holder 100, so that the phone 200 can always capture the face.

More specifically, when control signals are sent to the phone holder 100 based on the position relationship between the target face and the phone 200, the phone holder 100 is controlled to move forward or backward, or rotate left or right as a whole, or the moving element 52 of the phone holder 100 is kept still, or the holding element 30 of the phone holder 100 is inclined forward or backward, or remains stationary.

In the interactive process of physically video chatting and interacting with the phone holder 100 controlled by the phone 200, optionally, as shown in FIG. 14, the gesture of the remote video chat object which is another person in the video chat with the user triggers the control command of the remote video chat object's phone 200 to the user's phone 200 (i.e., the host), so that the remote video chat object's phone 200 sends a control signal to the host, and then the host sends a control signal to the holding element 30 of the phone holder 100 that holds the host's phone 200, to control the movement of the holding element 30 of the phone holder 100 and/or the phone holder 100.

Specifically, first, the owner's phone 200 is held in the holding element 30 of the phone holder 100, and the owner's phone 200 and the remote video chat object's phone 200 enter the remote video chat mode; then, the remote video chat object's phone 200 recognizes the gesture of the remote video chat object and sends a remote control signal to the owner's phone 200 based on the recognized gesture of the remote video chat object, the owner's phone 200 receives the remote control signal and sends a remote recognition control signal to the phone holder 100 holding the owner's phone 200, so as to control the movement of the phone holder 100 holding the owner's phone 200 and/or the holding element 30 of the phone holder 100.

More specifically, when a remote recognition control signal is sent to the phone holder 100 based on the positional relationship between the target face and the phone 200, the phone holder 100 is controlled to move forward, backward, left, or right as a whole, or the moving element 52 of the phone holder 100 is controlled to remain stationary, or the holding element 30 of the phone holder 100 is controlled to tilt forward, tilt backward, or remain stationary.

Alternatively, the control command for the phone holder 100 by the phone 200 can be triggered by gestures in the video interface during video chat, so that the phone 200 sends a control signal to the phone holder 100 to remotely control the movement of the phone holder 100 and/or the holding element 30 of the phone holder 100.

Specifically, first, a phone 200 is held in the holding element 30 of the phone holder 100, and the phone 200 displays a video interface which comprises a window of the owner of the phone 200 held in the phone holder 100 and a window of a remote video chat object for video communication with the owner. Then, gestures appearing in the window of the remote video chat object are recognized by the phone 200, and based on the recognized gestures appearing in the window of the remote video chat object, a remote transformation control signal is sent to the phone holder 100 to control the movement of the phone holder 100 and/or the holding element 30 of the phone holder 100.

More specifically, when a remote conversion control signal is sent to the phone holder 100 based on the positional relationship between the target face and the phone 200, the phone holder 100 is controlled to move forward, backward, left, right, or the moving element 52 of the phone holder 100 is controlled to remain stationary, the holding element 30 of the phone holder 100 is controlled to tilt forward, tilt backward, or remain still.

During the interactive process of mapping and path planning achieved through the cooperation of the phone 200 and the phone holder 100, the phone 200 is held on the phone holder 100, and the phone 200 can use the front monocular camera and SLAM mapping technology to map the environment around the phone holder 100. It is worth mentioning that there is a difference in the ability of the monocular camera to obtain environmental image information and the ability of the depth camera or stereo camera to obtain environmental image information, especially the depth information of the environmental image. However, the camera of the phone 200 can cooperate with the phone's accelerometer, the electronic compass of the phone 200, and the cliff sensor 60 of the phone holder 100 to obtain a more complete positioning and perception capability. With the corresponding autonomous driving algorithm, it is possible to achieve autonomous environmental exploration and complete SLAM mapping technology and path planning for the intelligent interactive system for interactive phone holders.

Correspondingly, in one embodiment of the present invention, the phone holder 100 transmits the sensing data of its cliff sensor 60 to the phone 200, and the phone 200 performs mapping and/or path planning based on the image data from its camera, the sensing data from the phone's accelerometer, and the sensing data from the phone's electronic compass.

In one example of the present invention, the camera of the phone 200, the phone's accelerometer, the electronic compass of the phone 200, and the cliff sensor 60 of the phone holder 100 cooperate with each other, and the SLAM mapping technology and path planning technology are simulated and simulated on the V-REP robot simulation platform using the corresponding autonomous driving algorithm. The mapping effect and path planning effect are good. The cliff sensor 60 can be implemented as a TOF distance sensor 80.

In the interaction process of controlling the illumination light 101 of the phone holder 100 by the phone 200, the phone 200 can be kept on the phone holder 100, and the ambient environment of the phone 200, that is, the brightness of the environment where the phone holder 100 is located, can be obtained through the light sensor of the phone 200. When the brightness is less than a preset brightness value, the phone 200 sends a first illumination control signal to the phone holder 100 to control the illumination light 101 of the phone holder 100 to turn on.

In the process of interacting with the phone holder 100 to determine the battery information of the phone holder 100 through the sensing signal of the phone holder 100, the phone 200 can obtain the status of the information indicator lights 102 of the phone holder 100, and determine the battery level of the phone holder 100 based on the status of the information indicator lights 102. For example, when the status of the information indicator lights 102 is displaying the first preset color, it is determined that the battery level of the phone holder 100 is less than or equal to the first threshold value; when the status of the information indicator lights 102 is displaying the second preset color, it is determined that the battery level of the phone holder 100 is greater than the first threshold value and less than or equal to the second threshold value; when the status of the information indicator lights 102 is displaying the third preset color, it is determined that the battery level of the phone holder 100 is greater than the second threshold value and less than or equal to the third threshold value.

Specifically, in this exemplary embodiment of the present invention, a connection status recognition method for determining whether the phone 200 and the phone holder 100 are in a connected state is provided by the intelligent interactive system for interactive phone holder. The connection status recognition method determines whether the phone 200 and the phone holder 100 are in a connected state based on the interaction status between the phone 200 and the phone holder 100.

Specifically, first, it is preliminarily determined whether the phone 200 is in a clamped state by the phone holder 100. Then, when it is preliminarily confirmed that the phone 200 is in the clamped state, the phone 200 generates a first control signal which is used to control the clamping element 32 of the phone holder 100 to perform pitching motion, and the phone holder 100 adjusts its state based on the first control signal. Next, the acceleration data of the phone 200 and the data of the distance between the phone 200 and the clamping element 32 of the phone holder 100 are obtained. Then, based on the acceleration data and the data of the distance between the phone 200 and the clamping element 32 of the phone holder 100, it is determined whether the phone 200 is in a connected state with the phone holder 100.

During the process of preliminarily determining whether the phone 200 is in a clamped state by the phone holder 100, the clamped state of the phone 200 by the phone holder 100 can be preliminarily determined by the phone 200's acceleration sensor. For example, in some embodiments, when the phone 200 is clamped by the phone holder 100, the phone 200 is in a landscape mode. When the phone's acceleration sensor detects that the phone 200 is in the landscape mode, it is preliminarily determined that the phone 200 is clamped by the phone holder 100. The phone's acceleration sensor can detect the posture data of the phone 200 to determine whether the phone 200 is in the landscape mode.

In some other embodiments, when the phone 200 is clamped by the phone holder 100, the phone 200 is in a vertical screen state. When the phone accelerometer detects that the phone 200 is in a vertical screen state, it preliminarily determines that the phone 200 is in the clamped state. The phone 200 can determine whether it is in the vertical screen state based on the pose data of the phone 200 detected by the phone accelerometer.

The first control signal comprises a forward tilt control signal and a backward tilt control signal. When the phone 200 sends the forward tilt control signal to the phone holder 100, the phone 200 controls the clamping element 32 of the phone holder 100 to tilt forward; when the phone 200 sends the backward tilt control signal to the phone holder 100, the phone 200 controls the clamping element 32 of the phone holder 100 to tilt backward.

In the process of obtaining the acceleration data of the phone 200 and the data of the distance between the phone 200 and the clamping element 32 of the phone holder 100, the acceleration data of the phone 200 is obtained by the phone accelerometer, and the data of the distance between the phone 200 and the clamping element 32 of the phone holder 100 is obtained by the proximity detection sensor of the phone holder 100. The phone holder 100 transmits the data of the distance between the phone 200 and the clamping element 32 to the phone 200.

If the phone holder 100 is communicatively connected to the phone 200, after receiving the first control signal of the phone holder 100, the clamping element 32 of the phone holder 100 will move in a manner corresponding to the first control signal, thereby driving the phone 200 to move in a manner corresponding to the first control signal, so that the acceleration detected by the phone's accelerometer is the standard acceleration value corresponding to the first control signal.

In the process of determining whether the phone 200 is in a connected state with the phone holder 100 based on the acceleration data and the distance data between the phone 200 and the clamping element 32 of the phone holder 100, when the acceleration data of the phone 200 changes as expected, that is, the difference between the acceleration data of the phone 200 and the standard acceleration value is less than or equal to the preset value, it is preliminarily determined that the phone 200 is communicatively connected to the phone holder 100, and the phone 200 is clamped to the phone holder 100 and connected to the phone holder 100 in hardware. The difference between the acceleration data of the phone 200 and the standard acceleration value can be represented by the absolute value of the difference between the acceleration data of the phone 200 and the standard acceleration value, or by other values, such as the absolute value of the ratio between the difference between the acceleration data of the phone 200 and the standard acceleration value and the standard acceleration value. Furthermore, when the data of the distance between the phone 200 and the clamping element 32 of the phone holder 100 is less than or equal to the preset distance value, it is finally determined that the phone 200 is communicatively connected to the phone holder 100, and the phone 200 is clamped to the phone holder 100 and connected to the phone holder 100 in hardware.

According to the interaction mode between the phone 200 and the phone holder 100 as described above, this application proposes a corresponding smart interaction method, which comprises: S110, the phone 200 generates at least one control signal, wherein the phone 200 and at least one phone holder 100 are communicatively connected; and S120, based on the control signal, the phone 200 and the phone holder 100 cooperate with each other to perform corresponding emotional expression groups; wherein the phone 200 and the phone holder 100 cooperate with each other to perform corresponding emotional expression groups comprising: the phone 200 displays at least one expression pattern or expression animation, the phone holder 100 performs at least one basic action, and the phone holder 100 adjusts the state of the information indicator lights 102 in one or more ways.

In some embodiments of this application, the expression patterns comprise happy patterns, sad patterns, angry patterns, and contempt patterns, and the expression animations include photo-taking animation, listening animation, right-looking animation, angry animation, surprised animation, and contempt animation. The basic actions comprise forward, backward, left turn, right turn, forward tilt, and backward tilt. The state of the information indicator lights 102 comprises continuous, blinking, gradient, left sweep, right sweep, and center diffusion.

In some embodiments of the present invention, when the phone holder 100 performs a forward basic action, the phone holder 100 moves forward as a whole; when the phone holder 100 performs a backward basic action, the phone holder 100 moves backward as a whole; when the phone holder 100 performs a left turn basic action, the phone holder 100 rotates to the left as a whole; when the phone holder 100 performs a right turn basic action, the phone holder 100 rotates to the right as a whole; when the phone holder 100 performs a forward tilt action, the suspension part of the phone holder 100 rotates forward; when the phone holder 100 performs a backward tilt basic action, the suspension part of the phone holder 100 rotates backward.

In some embodiments of the present invention, when the information indicator lights 102 are in a continuous state, the information indicator lights 102 maintain the same light color and remain in the on state for more than the first preset time; when the information indicator lights 102 are in a flashing state, the information indicator lights 102 switch between two light colors within the second preset time, or switches between the on state and the off state; when the information indicator lights 102 are in a gradient state, the information indicator lights 102 gradually switch from one light color to another light color in a time difference manner within the third preset time; when the information indicator lights 102 are in a left sweep state, the plurality of information indicator lights 102 transition from one light color to another light color from left to right; when the information indicator lights 102 are in a right sweep state, the plurality of information indicator lights 192 transition from one light color to another light color from right to left; when the information indicator lights 102 is in a center diffusion state, the plurality of information indicator lights 102 transition from one light color to another light color from the information indicator light 102 located in the center to the information indicator light 102 located on the periphery.

In some embodiments of the present invention, the control command of the phone holder 100 is triggered by the sensing data of the sensor of the phone holder 100, and the phone 200 generates at least one control signal comprising at least one sensor of the phone holder 100 generates induction data; the holder controller 20 of the phone holder 100 sends a signal to the phone 200 based on the induction data; and the phone 200 generates the control signal based on the signal sent by the phone holder 100.

In some embodiments of the present invention, the sensors of the phone holder 100 comprises the cliff sensor 60, the obstacle avoidance sensor 70, the TOF distance sensor 80, and the touch sensor.

In some embodiments of the present invention, the phone 200 generates at least one following control signal. The cliff sensor 60 of the phone holder 100, located at the front of the phone holder 100, generates cliff distance sensing data, and the data of the cliff distance sensing is within the preset cliff sensing distance range; the holder controller 20 of the phone holder 100 sends a signal to the phone 200 based on the cliff distance sensing data; and the phone 200 generates the control signal based on the signal sent by the phone holder 100; based on the control signal, the phone 200 and the phone holder 100 cooperate with each other to perform the corresponding emotional expression group, such as the phone 200 displays a surprised animation, the phone holder 100 retreats and then turns left at a preset angle.

In some embodiments of the present invention, the phone holder 100 is controlled by the phone 200 based on sensing data from the phone 200; the phone 200 generates at least one following control signal: at least one sensor of the phone 200 generating sensing data; and the phone 200 generating the control command based on the sensing data of the phone 200.

In some embodiments of the present invention, the sensors of the phone 200 comprise phone acceleration sensors, phone acceleration sensors, phone acceleration sensors, and a camera.

In some embodiments of the present invention, the phone 200 generates at least one following control signal: the sensors of the phone 200 generating sensing data, and the phone 200 generating the control command based on the sensing data of the phone 200.

In some embodiments of the present invention, the phone 200 generates at least one following control signal. The acceleration sensor of the phone 200 generates acceleration data; in response to the acceleration data exceeding a preset acceleration threshold and the phone 200 is determined to not execute an impact detection program; and the phone 200 generates a control command, based on the control command the phone 200 and the phone holder 100 cooperate with each other to perform a corresponding emotional expression group, comprising: the phone 200 first displaying a “surprised” animation, then displaying a “disdain” animation, the phone holder 100 performs a backward movement of a preset first distance, then tilting backward at a preset first angle, then moving forward at a preset second distance, and finally tilting forward at a preset second angle.

In some embodiments of the present invention, the phone holder 100 is controlled by the phone 200 through sensing data. The phone 200 generates at least one control signal comprising: at least one sensor of the phone 200 generates sensing data; at least one sensor of the phone holder 100 generates sensing data; the phone holder 100 sends a signal to the phone 200 based on the sensing data generated by its sensor; and the phone 200 generates the control signal based on the sensing data generated by its sensor and the signal sent by the phone holder 100.

In some embodiments of the present invention, the smart interaction method further comprises the following steps: placing the phone 200 on the phone holder 100; performing face recognition using the phone 200; in response to the phone 200 identifying a target face, obtaining the positional relationship between the target face and the phone 200; sending a control signal to the phone holder 100 based on the positional relationship between the target face and the phone 200; and moving the phone holder 100 based on the control signal.

In some embodiments of the present invention, the smart interaction method further comprises the following steps: placing the phone 200 of the owner on the phone holder 100; controlling the phone 200 of the owner and the phone 200 of the remote video chat object to enter a remote video chat mode; the phone 200 of the remote video chat object sends a remote control signal to the phone 200 of the owner; the phone 200 of the owner receives the remote control signal and sends a remote recognition control signal to the phone holder 100 holding the phone 200 of the owner; and moving the phone holder 100 based on the remote recognition control signal.

In some embodiments of the present invention, the smart interaction method further comprises the following steps: keeping the phone 200 on the phone holder 100; the phone holder 100 transmits the sensing data of its cliff sensor 60 to the phone 200; and the phone 200 performs mapping and/or path planning based on the image data from its camera, the sensing data from the phone's accelerometer, and the sensing data from the phone's electronic compass.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and are subject to change without departure from such principles. Therefore, this invention comprises all modifications encompassed within the spirit and scope of the following claims.

What is claimed is:

1. An intelligent interaction method, comprising the following steps:
(a)generating a control signal by a phone which is communicatively connected to a phone holder; and
(b)based on said control signal, performing a corresponding emotional expression group by said phone and said phone holder which cooperate with each other, wherein said emotional expression group comprises: displaying at least one of expression pattern and expression animation by said phone, and performing at least one basic action by said phone holder.

2. The intelligent interaction method, as recited in claim 1, wherein said expression pattern comprises one of happy pattern, sad pattern, angry pattern, and contempt pattern, wherein said expression animation comprises one of taking pictures animation, listening animation, looking right animation, angry animation, surprised animation, and contempt animation, wherein said basic action comprises one of forward movement, backward movement, left turn, right turn, forward tilt, and backward tilt.

3. The intelligent interaction method, as recited in claim 2, wherein when said phone holder performs said basic action of forward movement, said phone holder moves forward as a whole; when said phone holder performs said basic action of backward movement, said phone holder moves backward as a whole; when said phone holder performs said basic action of left turn, said phone holder turns left as a whole; when said phone holder performs said basic action of right turn, said phone holder turns right as a whole; when said phone holder performs said base action of forward tilt, a holding element of said phone holder rotates forward; when said phone holder performs said basic action of backward tilt, said holding element of said phone holder rotates backward.

4. The intelligent interaction method, as recited in claim 3, wherein said emotional expression group further comprises a step of adjusting a status of an information indicator light on said phone holder in one or more ways, wherein said status of said information indicator light comprises one of continuous lighting, blinking, gradient, left sweep, right sweep, and center diffusion, wherein when said information indicator light is in a continuous state, within a first preset time, said information indicator light maintains said same light color and remains in a lit state; when said information indicator light is in a flashing state, within a second preset time, said information indicator light switches between two light colors or switches between an on state and an off state; when said information indicator light is in a gradient state, within a third preset time, said information indicator light gradually switches from one light color to another light color in a time difference manner; when in a left sweep state, a plurality of said information indicator lights transition from one light color to another light color from left to right; when in a right sweep state, said plurality of information indicator lights transition from one light color to another light color from right to left; when in a center diffusion state, said plurality of information indicator lights transition from one light color to another light color from a centrally located information indicator light to a peripherally located information indicator light.

5. The intelligent interaction method, as recited in claim 4, wherein a control command of said phone holder is triggered by sensing data of sensors of said phone holder, wherein a step of sending a control signal from said phone comprising the steps of generating sensing data by at least one said sensor of said phone holder, sending a signal to said phone based on said sensing data by a holder controller of said phone holder, and generating said control signal by said phone based on said signal sent by said phone holder.

6. The intelligent interaction method, as recited in claim 5, wherein said sensors of said phone holder comprises one of cliff sensor, obstacle avoidance sensor, TOF distance sensor, and touch sensor.

7. The intelligent interaction method, as recited in claim 6, wherein the step of generating said control signal by said phone comprises the steps of:
generating cliff distance sensing data by said cliff sensor of said phone holder located at a front of said phone holder, wherein said cliff distance sensing data is within a preset cliff sensing distance range;
sending a signal to said phone based on said cliff distance sensing data by said holder controller of said phone holder; and
generating said control signal by said phone based on said signal sent by said phone holder, wherein based on said control signal, said phone and said phone holder cooperate with each other to perform said corresponding emotional expression group comprising: displaying a surprised animation by said phone, retreating said phone holder, and then turning said hone holder left at a preset angle.

8. The intelligent interaction method, as recited in claim 4, wherein said phone triggers control instructions to said phone holder based on sensing data of said phone, wherein the step of generating at least one control signal for said phone comprises the steps of generating sensing data by at least one sensor of said phone, and generating said control instructions by said phone based on said sensing data of said phone.

9. The intelligent interaction method, as recited in claim 8, wherein said at least one sensor of said phone comprises one of phone acceleration sensor, phone gyroscope, phone gyroscope, and camera.

10. The intelligent interaction method, as recited in claim 9, wherein acceleration sensor of said phone generates acceleration data, in response to said acceleration data exceeding a preset acceleration threshold, and said phone not executing an impact detection program, said phone generates said control instructions;
based on said control signal, said phone and said phone holder cooperate with each other to perform said corresponding emotional expression groups comprising: said phone first displays a surprised animation, then displays a disdain animation, said phone holder performs a preset first distance retreat, then tilts back at a preset first angle, then moves forward at a preset second distance, and then tilts forward at a preset second angle.

11. The intelligent interaction method, as recited in claim 4, wherein said phone triggers a control command of said phone holder through sensing data of said phone, wherein the step of generating at least one control signal by said phone comprises the steps of:
generating sensing data by at least one sensor of said phone;
generating sensing data by at least one sensor of said phone holder;
sending a signal to said phone from said phone holder based on said sensing data generated by said at least one sensor of said phone holder; and
generating said control signal based on said sensing data generated by said at least one sensor of said phone and said signal sent by said phone holder.

12. The intelligent interaction method, as recited in claim 1, further comprising the following steps:
keeping said phone on said phone holder;
performing face recognition through said phone;
in response to said phone identifying said target face, obtaining said position relationship between said target face and said phone;
sending a control signal to said phone holder based on said position relationship between said target face and said phone; and
moving said phone holder based on said control signal.

13. The intelligent interaction method, as recited in claim 1, further comprising the following steps:
keeping said phone of an owner on said phone holder;
controlling said phone of said owner and a phone of a remote video chat object to enter a remote video chat mode;
sending a remote control signal to said phone of said owner from the phone of said remote video chat object;
receiving said remote control signal by said phone of said owner and sending a remote recognition control signal to said phone holder holding said phone of said owner;
moving said phone holder based on said remote recognition control signal.

14. The intelligent interaction method, as recited in claim 1, further comprising the following steps:
holding said phone in said phone holder;
transmitting sensing data of a cliff sensor on said phone holder to said phone; and
based on image data from a camera, sensing data from an accelerometer of said phone, and sensing data from an electronic compass of said phone.

15. The intelligent interaction method, as recited in claim 1, further comprising a step of determining that said phone is magnetically attracted to said phone holder when a hall sensor senses a change in a magnetic filed around said hall sensor.

16. An interactive phone holder, comprising:
an installation base; and
a magnetic holding element provided on said installation base, wherein said magnetic holding element comprises a holding shell, a magnetic attracting member proved on said holding shell; and a hall sensor installed on said holding shell.

17. The interactive phone holder, as recited in claim 16, wherein said magnetic holding element is movable mounted to said installation base in a manner that said magnetic holding element is allowed to be switched between a forward tilt state and a backward tilt state.

18. The interactive phone holder, as recited in claim 16, further comprising a driving motor and a moving element which is driven by said driving motor to shift between forward movement, backward movement, left turn and right turn.

19. The interactive phone holder, as recited in claim 16, further comprising one of a cliff sensor, an obstacle avoidance sensor, and a TOF distance sensor which is mounted on said installation base.

20. The interactive phone holder, as recited in claim 16, further comprising one or more information indicator lights mounted on said installation base.
